(19) United States
(12) Patent Application Publication
(10) Pub. No.: US 2026/0355722 A1
(43) Pub. Date: Nov. 12, 2026

(54) DOPED TRANSITION-METAL ALUMINATES FOR DIRECT NOX DECOMPOSITION

(71) Applicant: Toyota Motor Engineering & Manufacturing North America, Inc., Plano, TX (US)

(72) Inventors: Griffin A. Canning, Ypsilanti, MI (US); Kimber L. Stamm Masias, Ann Arbor, MI (US); Charles Alexander Roberts, Farmington Hills, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/422,886

(22) Filed: Dec. 17, 2025

Related U.S. Application Data
(60) Provisional application No. 63/800,536, filed on May 6, 2025.

(51) Int. Cl. B01J 23/80; B01D 53/94

(52) U.S. Cl. CPC B01J 23/80; B01D 53/9418; B01D 2255/405; B01D 2257/404; B01D 2258/012

(57) ABSTRACT

A catalyst material for the catalytic conversion of NO into N₂, and free of platinum group metals, includes a mixed aluminum (Al) spinel oxide with a chemical formula of M1ₓM2_{y}M3_{z}Al_{w}O₄, and where M1 is calcium (Ca), magnesium (Mg), or zinc (Zn), M2 is cobalt (Co), copper (Cu), iron (Fe), manganese (Mn), or nickel (Ni), and M3 is Cu or Ni. Also, ‘x’ is greater than or equal 0.2 and less than or equal to 1.5 (0.2≤x≤1.5), ‘y’ is greater than or equal to 0.4 and less than or equal to 1.2 (0.4≤y≤1.2), ‘z’ is greater than or equal to 0.0 and less than or equal to 0.4 (0.0≤z≤0.4), and ‘w’ is greater than or equal to 0.8 and less than or equal to 2.2 (0.8≤w≤2.0).

### CROSS-REFERENCE TO RELATED APPLICATIONS

This application claims priority to U.S. Provisional Application No. 63/800,536 filed on May 6, 2025, which is incorporated herein in its entirety by reference.

### TECHNICAL FIELD

The present disclosure relates generally to NOx decomposition catalyst.

### BACKGROUND

The production of nitrogen oxides (NOx) during the burning of fossil fuels is known. Also, preventing the formation of NOx during the combustion process is effectively impossible, and thus catalysts are used to decompose NO into non-toxic products. For example, catalytic conversion of NO into nitrogen gas (N₂), and other non-toxic products, is accomplished using a catalytic converter in the exhaust system of vehicles.

Current NOx decomposition catalysts rely on rare metals such as rhodium, platinum and palladium, and the presence of reducing agents in the exhaust stream to completely decompose NO. The rare metals are expensive and the reducing agents are typically generated in situ by incomplete combustion of the fuel, thereby reducing engine efficiency.

Another technology, ammonia-selective catalytic reduction (NH₃—SCR), allows for simultaneous complete fuel combustion and NO decomposition via introduction of a reducing agent into a vehicle exhaust stream from a NH₃ reservoir located on the vehicle. Although NH₃—SCR improves engine efficiency and minimizes NO emissions, it requires periodic refilling of the NH₃ reservoir, which is both expensive and inconvenient, and results in another source of indirect CO₂ emissions related to vehicle operation.

The present disclosure addresses issues related to catalysts materials for the decomposition of NO and other issues related to catalyst materials.

### SUMMARY

In one form the present disclosure a catalyst material includes a mixed aluminum (Al) spinel oxide with a chemical formula of M1ₓM2_{y}M3_{z}Al_{w}O₄, and where M1 is calcium (Ca), magnesium (Mg), or zinc (Zn), M2 is cobalt (Co), copper (Cu), iron (Fe), manganese (Mn), or nickel (Ni), and M3 is Cu or Ni. Also, ‘x’ is greater than or equal 0.2 and less than or equal to 1.5 (0.2≤x≤1.5), ‘y’ is greater than or equal to 0.4 and less than or equal to 1.2 (0.4≤y≤1.2), ‘z’ is greater than or equal to 0.0 and less than or equal to 0.4 (0.0≤z≤0.4), and ‘w’ is greater than or equal to 0.8 and less than or equal to 2.2 (0.8≤w≤2.0).

In another form of the present disclosure, a catalyst material is a spinel oxide containing at least one of MgₓCo_{y}Al₂O₄, CaₓCo_{y}Al₂O₄, and ZnxCoyAl₂O₄, where x is between about 0.3 and about 0.7, and y is between about 0.3 and about 0.7.

In still another form of the present disclosure, a catalysts material is a spinel oxide containing at least one of CaₓMn_{y}Al₂O₄, CaₓFe_{y}Al₂O₄, CaₓCo_{y}Al₂O₄, CaₓNi_{y}Al₂O₄, and CaₓCu_{y}Al₂O₄, where x is between about 0.3 and about 0.7, and y is between about 0.3 and about 0.7.

### BRIEF DESCRIPTION OF THE DRAWINGS

The present teachings will become more fully understood from the detailed description and the accompanying drawings, wherein:

FIG. 1 shows a combustion exhaust containing NO flowing over a catalyst material according to the teachings of the present disclosure;

FIG. 2 illustrates an example synthesis route according to the teachings of the present disclosure;

FIG. 3 is a graphical plot of normalized N₂ production rate and N₂ selectivity, via NO catalytic conversion, provided by CoAl₂O₄, Mg_{0.5}Co_{0.5}Al₂O₄, Ca_{0.5}Co_{0.5}Al₂O₄, and Zn_{0.5}Co_{0.5}Al₂O₄ samples synthesized according to the teachings of the present disclosure;

FIG. 4 is a graphical plot of normalized N₂ production rate and N₂ selectivity, via NO catalytic conversion, provided by CoAl₂O₄, Ca_{0.5}Mn_{0.5}Al₂O₄, Ca_{0.5}Fe_{0.5}Al₂O₄, Ca_{0.5}Co_{0.5}Al₂O₄, Ca_{0.5}Ni_{0.5}Al₂O₄, and Ca_{0.5}Cu_{0.5}Al₂O₄ samples synthesized according to the teachings of the present disclosure;

FIG. 5A is a graphical plot of X-ray Photoelectron Spectroscopy (XPS) (O is electrons) performed on the CoAl₂O₄, Mg_{0.5}Co_{0.5}Al₂O₄, Ca_{0.5}Co_{0.5}Al₂O₄, and Zn_{0.5}Co_{0.5}Al₂O₄ samples synthesized according to the teachings of the present disclosure;

FIG. 5B is a graphical plot of X-ray Photoelectron Spectroscopy (XPS) (Co 2p^{3/2} electrons) performed on the CoAl₂O₄, Mg_{0.5}Co_{0.5}Al₂O₄, Ca_{0.5}Co_{0.5}Al₂O₄, and Zn_{0.5}Co_{0.5}Al₂O₄ samples synthesized according to the teachings of the present disclosure;

FIG. 6 is a graphical plot of in situ DRIFTS analysis of the Ca_{0.5}Co_{0.5}Al₂O₄ sample synthesized according to the teachings of the present disclosure;

FIG. 7A is a graphical plot of in situ DRIFTS analysis performed on the Ca_{0.5}Co_{0.5}Al₂O₄ sample after 30 minutes of NO adsorption at 100 °C;

FIG. 7B is a graphical plot of in situ DRIFTS analysis performed on the Ca_{0.5}Co_{0.5}Al₂O₄ sample after 30 minutes of desorption in He at 100 °C;

FIG. 7C is a graphical plot of in situ DRIFTS analysis performed on the Ca_{0.5}Co_{0.5}Al₂O₄ sample after 30 minutes of desorption in He at 300 °C;

FIG. 7D is a graphical plot of in situ DRIFTS analysis performed on the Ca_{0.5}Fe_{0.5}Al₂O₄ sample after 30 minutes of NO adsorption at 100 °C;

FIG. 7E is a graphical plot of in situ DRIFTS analysis performed on the Ca_{0.5}Fe_{0.5}Al₂O₄ sample after 30 minutes of desorption in He at 100 °C; and

FIG. 7F is a graphical plot of in situ DRIFTS analysis performed on the Ca_{0.5}Fe_{0.5}Al₂O₄ sample after 30 minutes of desorption in He at 300 °C.

### DETAILED DESCRIPTION

The present disclosure provides a class of catalyst materials, free of platinum group metals, that exhibit high catalytic performance and excellent stability when decomposing NO, without the aid of a reducing agent. The high performance without a reducing agent eliminates the need to incompletely burn fuel, thereby improving fuel efficiency, and avoids the use of expensive metals such platinum, palladium, rhodium, etc.

The catalyst materials according to the teachings of the present disclosure include mixed aluminum (Al) spinel oxides have the chemical formula M1ₓM2_{y}M3_{z}Al_{w}O₄, where: M1 is calcium (Ca), magnesium (Mg), or zinc (Zn), and ‘x’ is greater than or equal to 0.2 and less than or equal to 1.5 (0.2≤x≤1.5) including all subranges and values therebetween; M2 is cobalt (Co), copper (Cu), iron (Fe), manganese (Mn), or nickel (Ni) and ‘y’ is greater than or equal to 0.4 and less than or equal to 1.2 (0.4≤y≤1.2) including all subranges and values therebetween; M3 is Cu or Ni, and ‘z’ is greater than or equal to 0.0 and less than or equal to 0.4 (0.0≤z≤0.4) including all subranges and values therebetween; and ‘w’ is greater than or equal to 0.8 and less than or equal to 2.2 (0.8≤w≤2.2) including all subranges and values therebetween.

For example, ‘x’ can range between about 0.2 to about 1.3, about 0.2 to about 1.1, about 0.2 to about 0.9, about 0.2 to about 0.7, about 0.2 to about 0.5, about 0.2 to about 0.3, about 0.3 to about 1.5, about 0.5 to about 1.5, about 0.7 to about 1.5, about 0.9 to about 1.5, about 1.1 to about 1.5, about 1.3 to about 1.5, about 0.3 to about 1.3, about 0.5 to about 1.1, and about 0.7 to about 0.9.

Also, ‘y’ can range between about 0.4 to about 1.0, about 0.4 to about 0.8, about 0.4 to about 0.6, about 0.5 to about 1.2, about 0.6 to about 1.2, about 0.8 to about 1.2, about 1.0 to about 1.2, about 0.5 to about 1.1, about 0.6 to about 1.0, about 0.5 to about 0.9, and about 0.6 to about 0.8.

Also, ‘z’ can range between about 0.0 to about 0.3, about 0.0 to about 0.2, about 0.0 to about 0.1, about 0.1 to about 0.4, about 0.2 to about 0.4, about 0.3 to about 0.4, about 0.05 to about 0.35, about 0.1 to about 0.3, about 0.15 to about 0.30, about 0.2 to about 0.3, about 0.20 to about 0.25, and about 0.25 to about 0.3.

And ‘w’ can range between about 0.8 to about 2.0, about 0.8 to about 1.8, about 0.8 to about 1.6, about 0.8 to about 1.4, about 0.8 to about 1.2, about 0.8 to about 1.0, about 1.0 to about 2.2, about 1.2 to about 2.2, about 1.4 to about 2.2, about 1.6 to about 2.2, about 1.8 to about 2.2, about 2.0 to about 2.2, about 0.9 to about 2.0, about 1.1 to about 1.8, and about 1.3 to about 1.6.

In some variations, the M1ₓM2_{y}M3_{z}Al_{w}O₄ catalyst materials according to the teachings of the present disclosure include a mixed Co—Al spinel oxide containing one of calcium (Ca) or zinc (Zn), and one of copper (Cu) or nickel (Ni) as catalyst promoters. Typical metal atomic percentages (at %) exist in the ranges of between about 33 at % to about 66 at % Al, between about 15 at % to about 33 at % Co, between about 15 at % to about 33 at % Ca or Zn, and between about 3 at % to about 13 at % Cu or Ni, including all subranges and values therebetween. It should be understood that the “04” in the catalyst materials refers to catalyst materials in which the oxygen (O) is stoichiometric and catalyst materials in which there are permanent oxygen vacancies (i.e., “O₄₋ᵥ”). In some variations the M1ₓM2_{y}M3_{z}Al_{w}O₄ catalyst materials have a stoichiometric oxygen content, while in other variations the M1ₓM2_{y}M3_{z}Al_{w}O₄ catalyst materials have permanent oxygen vacancies and can be referred to as M1ₓM2_{y}M3_{z}Al_{w}O₄₋ᵥ.

For example, the Al content can be between about 33 at % to about 60 at %, about 33 at % to about 50 at %, about 33 at % to about 40 at %, about 35% to about 66 at %, about 40% to about 66 at %, about 50% to about 66 at %, about 60% to about 66 at %, about 33% to about 35 at %, about 35% to about 40 at %, about 45% to about 50 at %, about 50% to about 55 at %, about 55% to about 60 at %, and about 60% to about 65 at %.

Also, the Co, Ca, or Zn content can be between about 15 at % to about 30 at %, about 15 at % to about 25 at %, about 15 at % to about 20 at %, about 20% to about 33 at %, about 25% to about 33 at %, about 30% to about 33 at %, about 15% to about 20 at %, about 20 at % to about 25 at %, about 25 at % to about 30 at %, and about 30% to about 33 at %.

And the Cu or Ni content can be between about 3 at % to about 10 at %, about 3 at % to about 8 at %, about 3 at % to about 6 at %, about 3% to about 4 at %, about 4% to about 13 at %, about 6% to about 13 at %, about 8% to about 13 at %, about 10 at % to about 13 at %, about 12 at % to about 13 at %, about 5 at % to about 13 at %, about 6 at % to about 12 at %, and about 8 at % to about 10 at %.

Examples of catalyst compositions include CaₓCo_{y}Cu_{z}Al_{w}O₄, CaₓCo_{y}Ni_{z}Al_{w}O₄, and ZnₓCo_{y}Cu_{z}Al_{w}O₄, where for CaₓCo_{y}Cu_{z}Al_{w}O₄ x is between about 0.15 to about 0.55, e.g., between about 0.25 to about 0.45, y is between about 0.35 to about 0.75, e.g., between about 0.45 to about 0.65, z is between about 0.025 to about 0.175, e.g., between about 0.075 to about 0.125, and w is between about 1.5 to about 2.2, e.g., between about 1.75 to about 2.2. For CaₓCo_{y}Ni_{z}Al_{w}O₄, x is between about 0.8 to about 1.2, e.g., between about 0.9 to about 1.1, y is between about 0.8 to about 1.2, e.g., between about 0.9 to about 1.1, z is between about 0.1 to about 0.3, e.g., between about 0.15 to about 0.25, and w is between about 0.8 to about 1.2, e.g., between about 0.9 to about 1.1. And for ZnₓCo_{y}Cu_{z}Al_{w}O₄, x is between about 0.3 to about 0.7, e.g., between about 0.4 to about 0.6, y is between about 0.6 to about 1.0, e.g., between about 0.7 to about 0.9, z is between about 0.1 to about 0.3, e.g., between about 0.15 to about 0.25, and w is between about 1.0 to about 2.5, e.g., between about 1.5 and about 2.5, or between about 1.25 to about 1.75. In some variations, the CaₓCo_{y}Cu_{z}Al_{w}O₄, CaₓCo_{y}Ni_{z}Al_{w}O₄, and ZnₓCo_{y}Cu_{z}Al_{w}O₄ compositions are Ca_{0.35}Co_{0.55}Cu_{0.1}Al₂O₄, CaCoNi_{0.2}AlO₄, and Zn_{0.5}Co_{0.8}Cu_{0.2}Al_{1.5}O₄.

In other variations, the M1ₓM2_{y}M3_{z}Al_{w}O₄ catalysts materials according to the teachings of the present disclosure have a z index equal to 0.0 (i.e., M3 is not present) and include a mixed Co—Al or Fe—Al spinel oxide containing one of magnesium (Mg), Ca, or Zn as a catalyst promoter. Typical metal atomic percentages exist in the ranges of Al: 60-73 at %; and Ca, Mg, or Zn: 6-22 at %—together with Al totaling not more than 83 at % (i.e., (Ca, Mg, or Zn)+Al≤83 at %). Examples of catalyst compositions include MgₓCo_{y}Al_{w}O₄, CaₓCo_{y}Al_{w}O₄, and ZnₓCo_{y}Al_{w}O₄, where x is between about 0.3 to about 0.7, e.g., between about 0.4 to about 0.6, y is between about 0.3 to about 0.7, e.g., between about 0.4 to about 0.6., and w is between about 1.8 to about 2.2, e.g., between about 1.9 to about 2.1 In some variations, the MgₓCo_{y}Al₂O₄, CaₓCo_{y}Al₂O₄, and ZnₓCo_{y}Al₂O₄ compositions are Mg_{0.5}Co_{0.5}Al₂O₄, Ca_{0.5}Co_{0.5}Al₂O₄, and Zn_{0.5}Co_{0.5}Al₂O₄.

In still other variations, the M1ₓM2_{y}M3_{z}Al_{w}O₄ catalysts materials according to the teachings of the present disclosure have a z index equal to 0.0 (i.e., M3 is not present) and include a mixed Ca—Al spinel oxide containing one of manganese (Mn), iron (Fe), Co, Ni and Cu as a catalyst promoter. Typical metal atomic percentages exist in the ranges of Al: 60-73 at %, Ca: 6-22 at %—together with Al totaling not more than 83 at % (i.e., (Ca+Al≤83 at %), and Mn, Fe, Co, Ni, or Cu: 6-22 at %. Also, the subscript z=0.0. Examples of catalyst compositions tested include CaₓMn_{y}Al_{w}O₄, CaₓFe_{y}Al_{w}O₄, CaₓCo_{y}Al_{w}O₄, CaₓNi_{y}Al_{w}O₄, and CaₓCu_{y}Al_{w}O₄, where x is between about 0.3 to about 0.7, e.g., between about 0.4 to about 0.6, y is between about 0.3 to about 0.7, e.g., between about 0.4 to about 0.6, and w is between about 1.8 to about 2.2, e.g., between about 1.9 to about 2.2. In some variations, the CaₓMn_{y}Al₂O₄, CaₓFe_{y}Al₂O₄, CaₓCo_{y}Al₂O₄, CaₓNi_{y}Al₂O₄, and CaₓCu_{y}Al₂O₄ compositions are Ca_{0.5}Mn_{0.5}Al₂O₄, Ca_{0.5}Fe_{0.5}Al₂O₄, Ca_{0.5}Co_{0.5}Al₂O₄.

Not being bound by theory, cobalt aluminate spinel materials are promising candidates to overcome some of the limitations of the Co₃O₄ system for direct decomposition of NO at low temperatures. The addition of Al results in very strong Al—O bonds that limit solid-state ion mobility and a barrier to over-reduction and sintering of the catalyst. Furthermore, and rather than use catalyst promoters on the surface of a support (e.g., an alpha alumina support), the present disclosure incorporates catalyst promoters (dopants) into the crystal lattice of a spinel oxide. And by incorporating the catalyst promoters into the crystal lattice, removal of catalytic material from the support surface by exhaust gases is reduced and the lifetime of such a catalyst material is improved.

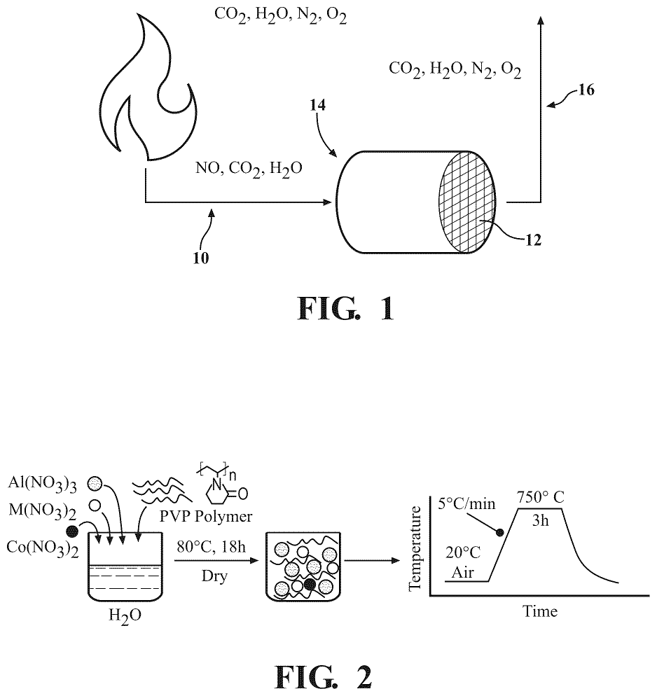

In some variations, the catalyst promoters (dopants) were chosen for their ability to form a stable Al containing spinel oxide phase, the stability of their 2+ oxidation state, and small ionic radii. The catalyst material according to the teachings of the present disclosure can be used in powder form, pressed with a binder into extrudates, or wash coated onto a substrate. For example, and with reference to FIG. 1, combustion exhaust 10 containing NO flows into contact with a catalyst material 12 (e.g., a catalyst material 12 that is part of a catalytic converter 14 of vehicle) at a predefined reaction temperature, and the catalyst material 12 binds the NO and converts it into N₂ and O₂ before it is released as exhaust gas 16.

Samples of the M1ₓM2_{y}M3_{z}Al_{w}O₄ spinel oxides were synthesized as discussed below, subjected to flowing NO in order to evaluate catalysis thereof and N₂ production rates provide by the various spinel oxides. Also, various samples were subjected to x-ray diffraction (XRD), x-ray photoelectron spectroscopy (XPS), and/or Fourier-transform infrared spectroscopy (FTIR) in the form of diffuse reflectance infrared Four-transform spectroscopy (DRIFTS) in order to characterize the samples and study the catalytic mechanism thereof. The following provides details of the synthesis, testing, characterization, and catalytic mechanism(s) of the samples.

### Catalyst Synthesis

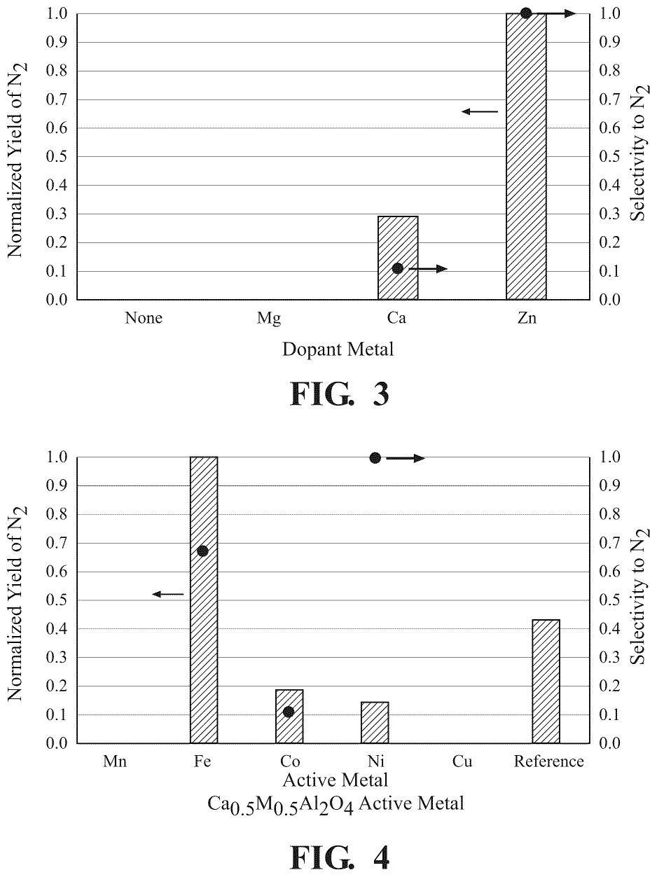

Metal ions were dissolved in a solution that contained 3.1 grams (g) of polyvinylpyrrolidone (PVP) polymer per gram of final product, which corresponded to a ratio of 1.5-1.7 PVP monomer units per metal ion. The solution was dried overnight to obtain a solid powder and then calcined in air to produce a final spinel product. It should be understood that interactions between the PVP and metal ions during drying prevented phase segregation of nitrate ions during drying. All solid powder samples were synthesized using a calcination temperature of 750 °C for 3 h with a 5 °C/min ramp rate. FIG. 2 provides an illustration of an example synthesis route used to form a final spinel product.

X-ray diffraction (XRD) was used to confirm the synthesis route described above and a spinel peak pattern was observed for each sample.

### Catalytic Behavior

Solid powder samples of M1ₓM2_{y}M3_{z}Al_{w}O₄ spinel oxides were tested for low-temperature, direct NO decomposition in a packed-bed reactor. Particularly, and after a 1 hour (h) helium (He) pretreatment at 500 °C, flow of an inlet stream of 1 volume percent (vol %) NO, balance argon (Ar) was brought into contact with the solid powder samples at 400 °C for 6 h at a gas hourly space velocity (GHSV) between 6500-7000 h⁻¹, and the resulting production of N₂ gas was measured and recorded.

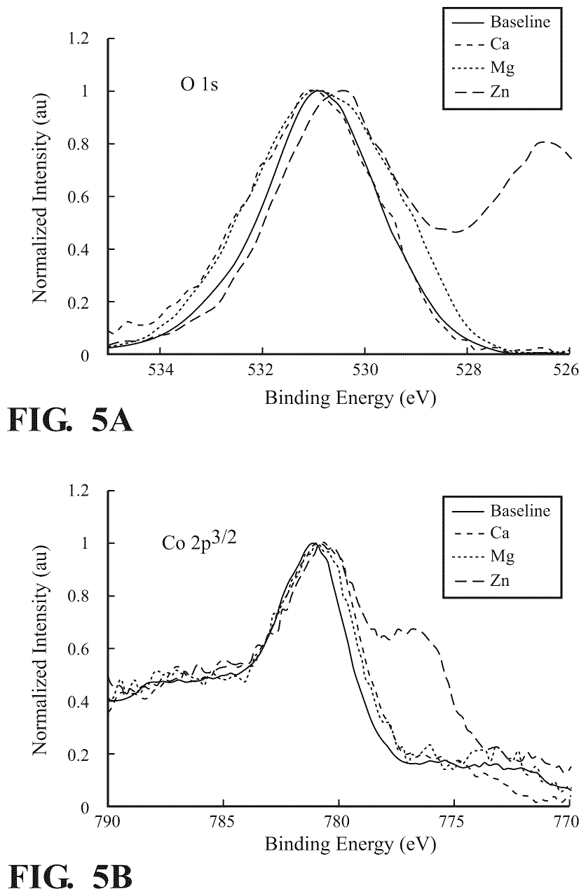

Referring to FIG. 3, normalized N₂ production rate and N₂ selectivity (black dots in figure) for solid powder samples of the un-doped CoAl₂O₄ (labeled “none”) and the M1ₓM2_{y}M3_{z}Al_{w}O₄ spinel oxides having the chemical formulas Mg_{0.5}Co_{0.5}Al₂O₄, Ca_{0.5}Co_{0.5}Al₂O₄, and Zn_{0.5}Co_{0.5}Al₂O₄ is shown. The CoAl₂O₄ sample and the Mg_{0.5}Co_{0.5}Al₂O₄ sample showed no measurable catalytic activity under the conditions described above, but the Ca_{0.5}Co_{0.5}Al₂O₄ and Zn_{0.5}Co_{0.5}Al₂O₄ samples did show a measurable conversion. Also, both of the Ca_{0.5}Co_{0.5}Al₂O₄ and Zn_{0.5}Co_{0.5}Al₂O₄ samples showed no measurable drop in catalytic rate over 6 h, thereby demonstrating stable thermal and/or catalytic stability of these two samples.

In addition to N₂ production rate, the selectivity to N₂ (i.e., the reduction of NO to N₂), defined as the rate of N₂ production divided by the rate of NO decomposition, was calculated for each of the CoAl₂O₄, Mg_{0.5}Co_{0.5}Al₂O₄, Ca_{0.5}Co_{0.5}Al₂O₄, and Zn_{0.5}Co_{0.5}Al₂O₄ samples (see Table 1 below). Other products produced were NO₂, but rarely N₂O. It should be noted that the Ca_{0.5}Co_{0.5}Al₂O₄ had higher rates of conversion of NO than Zn_{0.5}Co_{0.5}Al₂O₄, but due to the much lower selectivity of Ca_{0.5}Co_{0.5}Al₂O₄, the rate of formation of N₂ was lower than that for Zn_{0.5}Co_{0.5}Al₂O₄.

TABLE 1
Selectivity to N₂.

| Dopant | Selectivity to N₂ |
|---|---|
| None | — |
| Mg | — |
| Ca | 0.11 |
| Zn | 1.0 |

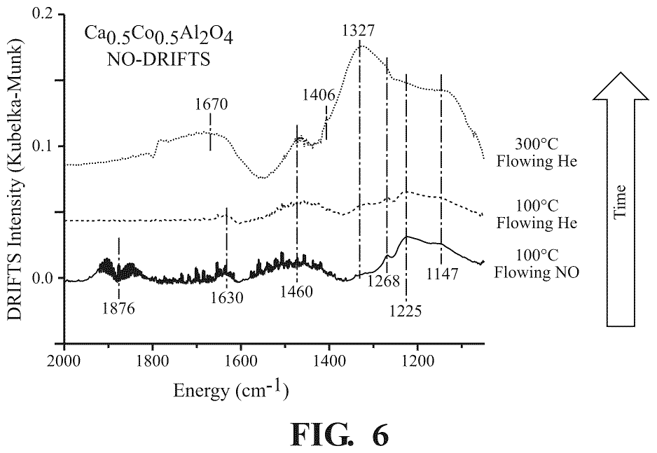

Referring to FIG. 4, normalized N₂ production rates and N₂ selectivity (black dots in the figure) for solid powder samples M1ₓM2_{y}M3_{z}Al_{w}O₄ spinel oxides where z=0, M1=Ca, M2=Mn, Fe, Co, Ni, and Cu, and having the chemical formulas Ca_{0.5}Mn_{0.5}Al₂O₄, Ca_{0.5}Fe_{0.5}Al₂O₄, Ca_{0.5}Co_{0.5}Al₂O₄, Ca_{0.5}Ni_{0.5}Al₂O₄, and Ca_{0.5}Cu_{0.5}Al₂O₄ are shown. Also the results for a reference Fe₃O₄ sample are shown. And as observed from FIG. 4, the catalytic rate of N₂ production followed the trend of Fe>Co>Ni>Mn═Cu for the above spinel oxides. That is, the Ca_{0.5}Fe_{0.5}Al₂O₄ sample exhibited the highest rate of N₂ production, followed by the Ca_{0.5}Co_{0.5}Al₂O₄ sample and the Ca_{0.5}Ni_{0.5}Al₂O₄ sample, with the Ca_{0.5}Mn_{0.5}Al₂O₄ and Ca_{0.5}Cu_{0.5}Al₂O₄ exhibiting no measurable N₂ production. The selectivity to N₂ for the solid powder samples with M2=Mn, Fe, Co, Ni, and Cu is also shown in FIG. 4 (right vertical axis).

It was also observed that the total rate of conversion of NO correlated with the energy required to remove one mole of oxygen from the most highly oxidized form of the metal M2 as shown in Table 2 below.

TABLE 2

| | Δ_{Grxn, 400 C} | Total Rate of |
|---|---|---|
| Reduction Reaction | (kJ) | NO Conversion |
| 2 Co₃O₄ → 6 CoO + O₂ | 180 | Highest |
| 6 Fe₂O₃ → 4 Fe₃O₄ + O₂ | 270 | Middle |
| 2 NiO → 2 Ni + O₂ | 340 | Lowest |

Catalyst Characterization of Co—Al Spinel Oxides Doped with Mg. Ca, or Zn

### XPS Analysis

Given that each of the synthesized samples had a spinel crystallographic structure, X-ray Photoelectron Spectroscopy (XPS) on the samples of mixed Co—Al spinel oxide doped with Mg, Ca or Zn was performed in an attempt to understand the impact of dopant on the electronic structure of the catalyst materials. Stated differently, since all of the synthesized samples had the same crystal structure and exhibited different catalytic behavior, XPS was performed on the samples in an attempt to explain the different catalytic behavior as a function of the electronic structure of each sample. It should be understood that XPS typically collects information from the top 5-10 nm of a sample.

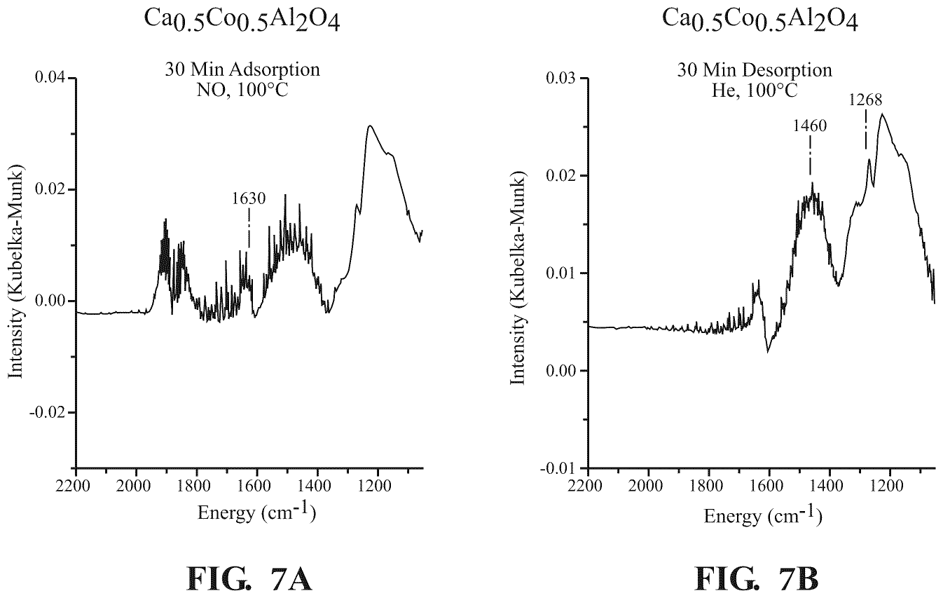

Referring to FIG. 5A, no clear trend in the electronic structure of the O 1s electrons in the CoAl₂O₄ sample and the Mg, Ca, and Zn doped samples was observed. Particularly, the peak height maximums for the Ca- and Mg-doped samples (531.0 and 530.8 eV, respectively) are near that of the baseline CoAl₂O₄ material (531.8 eV), which are in good agreement with an expected peak value for CoAl₂O₄ near 530.7-531.3 eV The peak for the Zn-doped material did shift towards lower binding energies, despite the expected peak position of ZnAl₂O₄ matching that of CoAl₂O₄. This shift to lower energies may indicate the presence of oxygen vacancies in this material.

Referring to FIG. 5B, XPS of the Co 2p^{3/2} electrons showed a more direct trend with respect to catalysis. The peak position shifted towards lower values in the order: baseline>Mg>Ca>Zn, thereby matching the catalytic results. Accordingly, and not being bound by theory, the higher electron density on Co lead to more rapid catalysis. In both spectra, the Zn_{0.5}Co_{0.5}Al₂O₄ sample showed a second peak at lower binding energies, but these peaks were due to charging and not included in the analysis.

### FTIR Analysis

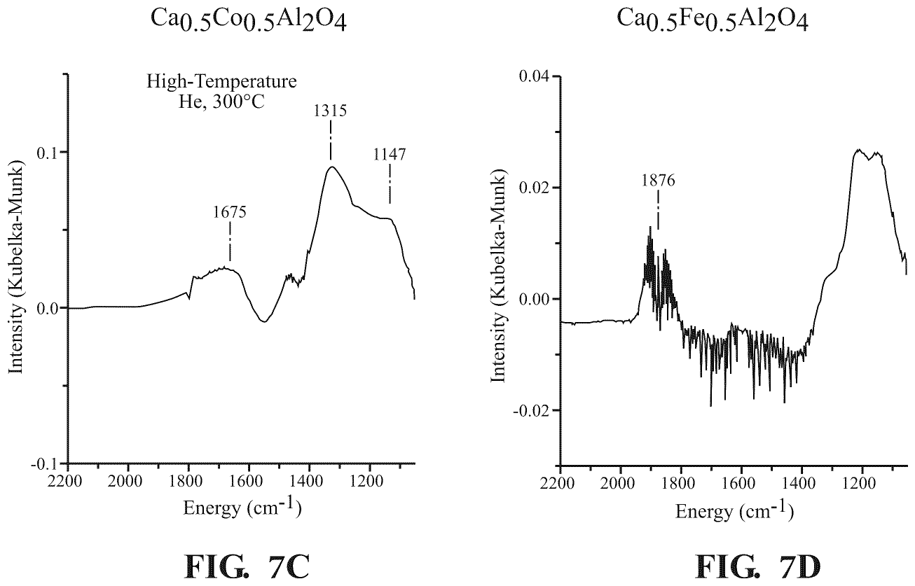

In situ DRIFTS analysis was performed to explore the type of species that adsorbed to the surface of a Ca_{0.5}Co_{0.5}Al₂O₄ sample and the changes the adsorbed species underwent under elevated temperature. The Ca_{0.5}Co_{0.5}Al₂O₄ sample was first given a 1 h, 300 °C treatment in flowing He to remove adsorbates and then cooled to 100 °C. Referring to FIG. 6, spectra taken after 30 minutes of NO adsorption at 100 °C, followed by 30 minutes of desorption in He at 100 °C, and after 30 minutes at 300 °C in He are shown. In general, the 100 °C in flowing NO spectra showed a limited absorption signal, indicating low concentrations of surface species. The limited absorption signal indicates the Al—O and Ca—O sites at dominate the surface do not bind significant amounts of NOₓ species, and that one of the main limits on catalytic performance was the amount of Co expressed in the surface of the Ca_{0.5}Co_{0.5}Al₂O₄ sample, and thus in all of the samples. The envelope of peaks centered at 1876 cm⁻¹ taken during NOₓ adsorption were from the gas-phase NO signal. The peak centered at 1630 cm⁻¹ was assigned to surface H₂O. The peaks at 1268 and 1147 cm⁻¹ were assigned to bidenate nitro groups, which were bound to the surface via both N and 0 atoms. The peak at 1308 cm⁻¹ corresponds to monodentate nitrito groups.

The broad increase in signal in the 300 °C in flowing He spectra between 1650-1050 cm⁻¹ did not arise from an increase in the total number of bound species, as the sample was only exposed to He at this time. Instead, the increase was likely dominated by a change in the solid material structure. Still, the appearance of specific features did indicate changes in binding modes due to the increase in temperature. The feature at 1327 cm⁻¹ was tentatively assigned to the free-nitrite like binding of NO₂⁻ to Ca, and its large increase may indicate spillover of Co or Fe bound NOₓ adsorbates, or a change in the absorption cross section of the species due to changes in the underlying solid. The broad peak at 1670 cm⁻¹ at 300 °C in flowing He similarly resulted from nitrate binding on Al sites. The feature that appears at 1406 cm⁻¹ and 1055-1065 cm⁻¹ at 300 °C are characteristic of the N₂O₂²⁻ dimer, thought to be an important intermediate in direct NO decomposition.

Not being bound by theory, the increased electron density on Co in the Ca_{0.5}Co_{0.5}Al₂O₄ sample as seen in XPS correlates with the appearance of reduced NOₓ⁻ species. Study of NO decomposition on K-promoted Co₃O₄ has indicated the nitrate and nitrite species as important indicators of catalytic activity in those materials. The same structure-function relationship is probably present in the catalyst materials according to the teachings of the present disclosure. Increased Co surface expression, increased electron density on the Co, and the formation of nitrates upon NO adsorption are all correlated with increased catalytic rates. Accordingly, use dopants to maximize these geometric and electronic features within cobalt aluminate catalysts is desirable.

Overall, the Mg-, Ca-, and Zn-containing Co—Al spinel oxides displayed phase-pure spinel diffraction patterns, with crystallite size increasing in the order of Ca<Mg<none<Zn. The Ca-containing material showed higher overall NO conversion, but the Zn-containing catalyst showed higher selectivity to and rate of formation of N₂. There was not a simple correlation between promoter properties such as electronegativity or ionic radius and the catalytic activity. Shifts towards lower binding energy of Co 2p^{3/2} electrons did correlate with higher catalytic activity. The shifts towards lower binding energy of Co 2p^{3/2} electrons were also correlated to the increased expression of Co on the surface of the catalyst and the formation of reduced NO₂⁻ species.

Catalytic Mechanism for the Ca_{0.5}Co_{0.5}Al₂O₄ and Ca_{0.5}Fe_{0.5}Al₂O₄ Samples

In situ DRIFTS analysis was also performed on the Ca_{0.5}Fe_{0.5}Al₂O₄ sample in order to compare the type of species that adsorbed to the surfaces of the Ca_{0.5}Co_{0.5}Al₂O₄ and Ca_{0.5}Fe_{0.5}Al₂O₄ samples during catalysis. The Ca_{0.5}Fe_{0.5}Al₂O₄ sample was given the same treatment as the Ca_{0.5}Co_{0.5}Al₂O₄ sample described above, i.e., a 1 h, 300 °C treatment in flowing He to remove adsorbates, cooling to 100 °C, 30 minutes of NO adsorption at 100 °C, 30 minutes of desorption in He at 100 °C, and 30 minutes at 300 °C in He.

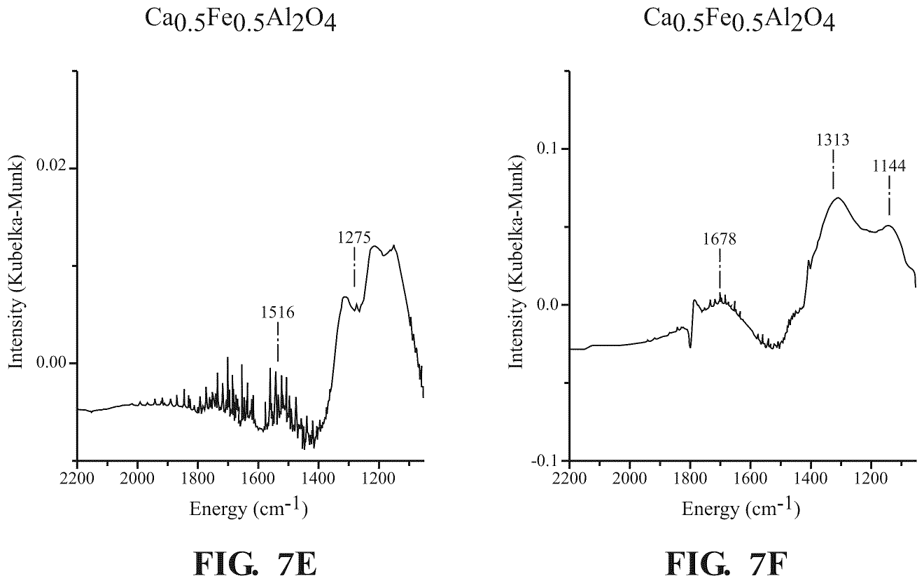

Referring FIGS. 7A-7F, FIGS. 7A-7C show the in situ DRIFTS spectra for Ca_{0.5}Co_{0.5}Al₂O₄ and FIGS. 7D-7F show the in situ DRIFTS spectra for Ca_{0.5}Fe_{0.5}Al₂O₄. Particularly, FIGS. 7A, 7D show the spectra after 30 minutes of flowing NO, FIGS. 7B, 7E show the spectra after 30 minutes of desorption in He, and FIGS. 7C, 7F show the spectra after 30 minutes at 300 °C. The peaks that appear for both samples centered at 1876 cm⁻¹ during NO adsorption are due to gas-phase NO.

The peak at 1630 cm⁻¹ in FIG. 7A indicates strongly bound surface water and is not present on the Fe containing sample. Both samples show absorption near 3500 cm⁻¹ (not shown) at 100 °C, indicative of surface —OH groups. This signal disappears at 300 °C. The peak near 1315 cm⁻¹ is assigned to nitrites formed Ca sites. Its large increase at elevated temperatures in both samples may result from spillover from Co/Fe sites, or changes to the absorption cross section due to changes in the solid. The peak near 1675 cm⁻¹ that likewise appears at high temperature is assigned to nitrate binding on Al sites.

The peaks at 1267/1147 cm⁻¹ in the Co sample and 1273/1148 cm⁻¹ in the Fe sample are characteristic of bidentate nitrito groups. The peak appearing near 1307-1308 cm⁻¹ in both samples is characteristic of monodentate nitrito groups, which can be important intermediates in the decomposition of NO. The bidentate nitrito groups may interconvert with the monodentate species on the catalyst surface according to gas phase NO concentration, temperature and pressure. Accordingly, the presence of the 1267/1147 cm⁻¹, 1273/1148 cm⁻¹, and 1307-1308 cm⁻¹ peaks provide evidence for the catalytic activity of these samples (FIG. 4). Note that for Co₃O₄ these peaks do not appear without the presence of K⁺ co-catalyst. Accordingly, the ability of Ca_{0.5}Co_{0.5}Al₂O₄ and Ca_{0.5}Fe_{0.5}Al₂O₄ samples to form nitrites without K⁺ is an advantage over previously studied spinel catalysts. Also, the presence of NO₂⁻ on active catalysts may help explain why N₂ formation is inversely proportional to electronegativity. Lower electronegativity metals should more readily donate electron density to bound NO species to form the anionic intermediate. At 300 °C, two new features appear at 1402 and 1065 cm⁻¹ for the Co containing sample and 1408 and 1055 cm⁻¹ containing sample. These peaks are assigned to the trans configuration of the N₂O₂²⁻ dimer species. These features are more distinctive on the Fe containing sample, indicating a correlation with catalytic activity. The rest of the features in the system are associated with species other than NOR. The broad peak centered between 1450-1475 cm⁻¹ in the Co containing spectra at 100 °C is associated with a C—O stretch when CO₂ interacts with —OH species on the catalyst surface. The lack of this peak in the spectra from the Fe containing sample is correlated with the lack of the water peak at 1630 cm⁻¹. Further, the peak at 1220-1210 cm⁻¹ at 100 °C is associated with C—O stretching in bound CO₂ not associated with hydroxyl groups.

The peaks at 1460/1268 cm⁻¹ in the Co sample and 1516/1275 cm⁻¹ in the Fe sample are characteristic of chelating nitro groups and can be important intermediates in the decomposition of NO. Accordingly, the presence of the 1460/1268 cm⁻¹ and 1516/1275 cm⁻¹ peaks provide evidence for the catalytic activity of these samples (FIG. 4). Note that for Co₃O₄ the 1460/1268 cm⁻¹ and 1516/1275 cm⁻¹ peaks do not appear without the presence of K⁺ co-catalyst. Accordingly, the ability of Ca_{0.5}Co_{0.5}Al₂O₄ and Ca_{0.5}Fe_{0.5}Al₂O₄ samples to form nitrates without K⁺ is an advantage over previously studied spinel catalysts. Also, the presence of NO₃⁻ on active catalysts may help explain why N₂ formation is inversely proportional to electronegativity. Lower electronegativity metals should more readily donate electron density to bound NO species to form the anionic intermediate. The peaks at 1460 and 1268 cm⁻¹ for the Co aluminate and 1516 and 1275 cm⁻¹ for the Fe-aluminate are assigned to chelating nitro groups. These features are much larger in the Co containing sample than the Fe sample, so their presence will continue to be monitored to see if they are predictive of low selectivity to N₂ and higher rates of NO₂ formation. The peaks at 1225 and 1147 cm⁻¹ in the Co sample and 1229 and 1146 cm⁻¹ in the Fe sample are assigned to monodentate nitrate species. And the monodentate nitrate species may be an important intermediate in NO decomposition, indicating the reaction mechanism may proceed through this intermediate on these catalyst samples.

Given the above, it should be understood that the present disclosure provides catalyst materials for the reduction of NO to N₂, and other non-toxic species. The catalyst materials are mixed Al spinel oxides that are free of platinum group metals and thus provide a cost reduction compared to traditional catalyst materials, e.g., traditional catalyst materials used in vehicle catalytic converters.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also, unless otherwise stated, include individual values (e.g., about 1%, about 2%, about 3%, about 4%, etc.) and the sub-ranges (e.g., about 0.5% to about 1.1%, about 0.5% to about 2.4%, about 0.5% to about 3.2%, about 0.5% to about 4.4%, and other possible sub-ranges) within the indicated range. It is also understood that there are a number of values disclosed herein, and that each value is also herein disclosed as “about” that particular value in addition to the value itself. For example, if the value “10” is disclosed, then “about 10” is also disclosed. Ranges may be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed. Also, the term “about” as used herein with respect to numerical values refers to values that fall with a +/−5% experimental error when measure or determining the values.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation may or may comprise certain elements or features does not exclude other forms or variations of the present technology that do not contain those elements or features.

The broad teachings of the present disclosure may be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not all method steps are required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and may be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A catalyst material comprising:
a mixed aluminum (Al) spinel oxide with a chemical formula of M1ₓM2_{y}M3_{z}Al_{w}O₄, where:
M1 is calcium (Ca), magnesium (Mg), or zinc (Zn), and 0.2≤x≤1.5;
M2 is cobalt (Co), copper (Cu), iron (Fe), manganese (Mn), or nickel (Ni) and 0.4≤y≤1.2;
M3 is Cu or Ni, and 0.0≤z≤0.4; and
0.8≤w≤2.0.

2. The catalyst material according to claim 1, wherein M1 is Ca or Zn, M2 is Co, and M3 is Cu or Ni.

3. The catalyst material according to claim 2, wherein a chemical composition, in atomic percent (at %), of the mixed Al spinel oxide comprises between about 15 at % to about 33 at % of Ca or Zn, between about 15 at % to about 33 at % Co, between about 3 at % to about 13 at % Cu or Ni, and between about 33 at % to about 66 at % Al.

4. The catalyst material according to claim 2, wherein the mixed Al spinel oxide is at least one of CaₓCo_{y}Cu_{z}Al_{w}O₄, CaₓCo_{y}Ni_{z}Al_{w}O₄, and ZnₓCo_{y}Cu_{z}Al_{w}O₄, where:
for CaₓCo_{y}Cu_{z}Al_{w}O₄, x is between about 0.3 and about 0.4, y is between about 0.45 and about 0.65, z is between about 0.025 and about 0.175, and w is between about 1.5 and 2.5;
for CaₓCo_{y}Ni_{z}Al_{w}O₄, x is between about 0.75 and about 1.25, y is between about 0.75 and about 1.25, z is between about 0.2 and about 0.3, and w is between about 0.8 and 1.5; and
for ZnₓCo_{y}Cu_{z}Al_{w}O₄, x is between about 0.25 and about 0.75, y is between about 0.6 and about 1.0, z is between about 0.1 and about 0.3, and w is between about 1.0 and 2.0.

5. The catalyst material according to claim 4, wherein:
for CaₓCo_{y}Cu_{z}Al_{w}O₄, x is about 0.24, y about 0.55, z about 0.1, and w is about 2.0;
for CaₓCo_{y}Ni_{z}Al_{w}O₄, x is about 1.0, y is about 1.0, z is about 0.2, and w is about 1.0; and
for ZnₓCo_{y}Cu_{z}Al_{w}O₄, x is about 0.5, y is about 0.8, z is about 0.2, and w is about 1.5.

6. The catalyst material according to claim 1, wherein z is 0.0 and the mixed Al spinel oxide is at least one of MgₓCo_{y}Al_{w}O₄, CaₓCo_{y}Al_{w}O₄, and ZnₓCo_{y}Al_{w}O₄, and x is between about 0.3 and about 0.7, y is between about 0.3 and about 0.7, and w is between about 1.5 and 2.5.

7. The catalyst material according to claim 6, wherein x is between about 0.4 and about 0.6, y is between about 0.4 and about 0.6, and w is between about 1.75 and 2.25.

8. The catalyst material according to claim 7, wherein x is about 0.5, y is about 0.5, and w is about 2.

9. The catalyst material according to claim 1, wherein z is 0.0 and the mixed Al spinel oxide is at least one of CaₓMn_{y}Al_{w}O₄, CaₓFe_{y}Al_{w}O₄, CaₓCo_{y}Al_{w}O₄, CaₓNi_{y}Al_{w}O₄, and CaₓCu_{y}Al_{w}O₄, ZnₓCo_{y}Al_{w}O₄, and x is between about 0.3 and about 0.7, y is between about 0.3 and about 0.7, and w is between about 1.8 and 2.2.

10. The catalyst material according to claim 9, wherein x is between about 0.4 and about 0.6, y is between about 0.4 and about 0.6, and w is between about 1.9 and 2.1.

11. The catalyst material according to claim 10, wherein x is about 0.5, y is about 0.5, and w is about 2.

12. A catalytic converter for a vehicle, the catalytic converter comprising the catalyst material according to claim 1.

13. A catalyst material comprising:
a spinel oxide comprising at least one of MgₓCo_{y}Al₂O₄, CaₓCo_{y}Al₂O₄, and ZnₓCo_{y}Al₂O₄, where x is between about 0.3 and about 0.7, and y is between about 0.3 and about 0.7.

14. The catalyst material according to claim 13, wherein x is between about 0.4 and about 0.6, and y is between about 0.4 and about 0.6.

15. The catalyst material according to claim 13, wherein a about 0.5, and y is about 0.5.

16. The catalyst material according to claim 15, wherein the spinel oxide is ZnₓCo_{y}Al₂O₄.

17. A catalyst material comprising:
a spinel oxide comprising at least one of CaₓMn_{y}Al₂O₄, CaₓFe_{y}Al₂O₄, CaₓCo_{y}Al₂O₄, CaₓNi_{y}Al₂O₄, and CaₓCu_{y}Al₂O₄, where x is between about 0.3 and about 0.7, and y is between about 0.3 and about 0.7.

18. The catalyst material according to claim 17, wherein x is between about 0.4 and about 0.6, and y is between about 0.4 and about 0.6.

19. The catalyst material according to claim 18, wherein a about 0.5, and y is about 0.5.

20. The catalyst material according to claim 19, wherein the spinel oxide is CaₓFe_{y}Al₂O₄.
